(19) United States
(12) Patent Application Publication
(10) Pub. No.: US 2009/0286154 A1
(43) Pub. Date: Nov. 19, 2009

(54) Process for the Preparation of an Electrolyte

(75) Inventors: Andries Gerhardus Dormehl, Middleburg (ZA); Daniel Frederick Dutton, Witbank (ZA)

Correspondence Address: PAULEY PETERSEN & ERICKSON, 2800 WEST HIGGINS ROAD, SUITE 365, HOFFMAN ESTATES, IL, 60169, US

(73) Assignee: HIGHVELD STEEL AND VANADIUM CORPORATION LIMITED, Witbank (ZA)

(21) Appl. No.: 12/083,788

(22) PCT Filed: Oct. 24, 2006
(86) PCT No.: PCT/IB2006/002984

§ 371 Date: Aug. 13, 2008

(30) Foreign Application Priority Data
Oct. 24, 2005 (ZA) 2005/08606

(51) Int. Cl. H01M 6/04

(52) U.S. Cl. 429/188

(57) ABSTRACT

The invention provides a process for preparing a crystalline vanadyl sulphate/vanadous sulphate material, the process including the steps of providing a mixture of vanadium pentoxide (V₂O₅) and vanadium trioxide (V₂O₃); adding to the mixture a predetermined volume of a sulphuric acid solution to produce a powder slurry; and heating the slurry at a temperature and for a time sufficient to form a crystalline vanadyl sulphate/vanadous sulphate material. The invention extends to a process for preparing an electrolyte from such a crystalline vanadyl/vanadous sulphate material, including the steps of dissolving the crystalline material in boiling water and adding a stabilising agent, typically phosphoric acid, to stabilise the electrolyte.

### BACKGROUND OF THE INVENTION

THIS invention relates to a process for the preparation of a crystalline vanadyl sulphate/vanadous sulphate material. It also extends to a process for preparing an electrolyte from such a crystalline vanadyl sulphate/vanadous sulphate material.

Vanadyl/vanadous sulphate solutions or electrolytes are becoming more and more important in various applications, including in the battery industry. A problem with the solutions, however, is that they are highly acidic and hazardous. Accordingly, there may be serious problems in transporting these products around the world.

U.S. Pat. No. 6,764,663 addresses this problem by providing a process in terms of which a vanadyl sulphate/vanadous sulphate solution is evaporated to produce vanadyl sulphate/vanadous sulphate crystals that are suitable for transport. These crystals can then be re-dissolved to form a reconstituted vanadyl sulphate/vanadous sulphate solution having substantially the same chemical composition as the starting material. The starting material is produced by forming a vanadous sulphate solution from a vanadyl sulphate solution electrolysed with sulphuric acid, and combining it with a further portion of vanadyl sulphate solution.

The present invention provides an alternative method of producing a crystalline vanadyl sulphate/vanadous sulphate material, and a method of producing an electrolyte from such vanadyl/vanadous sulphate material.

### SUMMARY OF THE INVENTION

According to the invention a process for preparing a crystalline vanadyl sulphate/vanadous sulphate material includes the steps of—
(i) providing a mixture of vanadium pentoxide (V₂O₅) and vanadium trioxide (V₂O₃);
(ii) adding to the mixture a predetermined volume of a sulphuric acid solution to produce a powder slurry; and
(iii) heating the slurry at a temperature and for a time sufficient to form a crystalline vanadyl sulphate/vanadous sulphate material.
The vanadium pentoxide is preferably a commercial grade vanadium pentoxide having a V₂O₅ content of 99.5% to 100% with limited impurity content.

The vanadium trioxide is preferably a commercial grade V₂O₃ powder having an equivalent V₂O₅ content of 110% to 125%, more preferably 115% to 122%, and most preferably 119% to 120%.

The sulphuric acid solution is preferably greater than 98% pure sulphuric acid.

The relative amounts of V₂O₃ and V₂O₅ are dependent on the required molar concentration in the vanadyl sulphate/vanadous sulphate material, but are generally in the order of 3 V₂O₃:1 V₂O₅ w/w. Thus, for a 2 molar final product, the ratio of V₂O₃ to V₂O₅ is about 13:4, and for a 1.6 molar product it is about 11:3.7.

The amount of sulphuric acid is also dependent on the molarity of the final product. Thus, for instance, for a 2 molar final product utilising 13 grams V₂O₃ and 4 grams V₂O₅, 26 ml of sulphuric acid (>98%) are required. Likewise, for a 1.6 molar final product utilising 11 grams of V₂O₃ and 3.7 grams of V₂O₅, 22.6 ml of sulphuric acid (>98%) are required.

A stabilising agent, preferably in the form of chemically pure phosphoric acid, is preferably used to stabilise the electrolyte produced from the crystalline vanadyl sulphate/vanadous sulphate material. The electrolyte can be produced by dissolving the crystalline material in boiling water, preferably in a 50:50 w/w ratio.

In one embodiment of the invention, the phosphoric acid is added to the sulphuric acid and slurried with the powder mixture prior to the slurry being heated to form the crystalline material. In this embodiment, an electrolyte can be produced simply by dissolving the crystalline material in boiling water, preferably in a 50:50 w/w ratio.

In an alternative embodiment, the crystalline material is first dissolved in boiling water to which the phosphoric acid is added to produce the electrolyte.

The reaction of the starting material and sulphuric acid, and where appropriate the stabilising agent, is carried out for a period of 30 to 240 minutes, preferably for about 45 to 60 minutes, and at a temperature of about 25° C. to 230° C., preferably a temperature of 200° C. to 220° C.

The crystalline material is typically cooled, crushed and then vacuum packed for delivery.

The process preferably takes place in an inert atmosphere, typically a sealed reaction chamber that is flooded with nitrogen, argon or other appropriate inert gas.

The mixing step of the starting mixture and sulphuric acid is preferably a homogenous mixing step, preferably using a high intensity mixer.

### DESCRIPTION OF EMBODIMENTS

The crux of the invention is a process for the preparation of a crystalline vanadyl sulphate/vanadous sulphate material with a specified molar concentration, from a first starting material containing V₂O₅ and a second starting material containing V₂O₃, and a sulphuric acid solution.

The reaction proceeds according to the following formula:

V₂O₃+V₂O₅+4H₂SO₄→4VOSO₄+4H₂O

The reaction between the V₂O₅, V₂O₃ and sulphuric acid solution is highly exothermic, and requires careful control. In addition, it is very important that a homogenous mixture of V₂O₃ and V₂O₅ is provided, and that the whole of the homogenous mixture is contacted by the sulphuric acid, to avoid localised reactions taking place. The mixture of V₂O₃ and V₂O₅ is produced in a high intensity mixer, to which the sulphuric acid is added.

Regarding the reaction chamber, an inert atmosphere is required. The reaction chamber therefore needs to be sealed and is flushed with nitrogen, argon or other inert gas to maintain the inert atmosphere.

Once the V₂O₃/V₂O₅ mixture and sulphuric acid have been thoroughly mixed, the reaction mixture is heated at a temperature of no less than 25° C. and no more than 230° C. A temperature of 200 to 220° C. is preferred.

The heating step is continued for a period of 30 to 240 minutes, 45 to 60 minutes being preferred. The matured crystalline material is cooled, crushed and vacuum processed. It can then be reconstituted with water to produce the electrolyte.

It is also important that the electrolyte is stabilised. This is done by adding a stabilising agent, typically phosphoric acid, to the mixture prior to the maturing step or to the reconstituted vanadyl sulphate/vanadous sulphate solution. In the former case the electrolyte is simply produced by adding the crystalline material to boiling water in a ratio of about 50:50 w/w. In the latter case, the crystalline material is dissolved in boiling water and then the phosphoric acid is added to the electrolyte.

The advantages of the process of the invention include less environmental risk during transport, 75% less material to handle, hence lowering transport costs, and no electrolysis is required for polishing the crystalline material, hence reducing production time and costs.

### EXAMPLES

TABLE 1
Results obtained after reconstitution of the fused
material with varying Hivox composition.

| | Trial 1 | Trial 2 | Trial 3 | Trial 4 | Specification |
|---|---|---|---|---|---|
| V molar | 2.19 | 2.12 | 2.15 | 2.14 | 2.1 |
| SO₄ molar | 4.8 | 4.7 | 4.5 | 4.55 | 4.6 |
| Ratio V³⁺:V⁴⁺ | 0.96:1.0 | 1.0:0.98 | 1.0:1.03 | 1.0:0.92 | 1.0:1.0 |
| Hivox (% V₂O₅) | 118 | 119 | 117 | 120 | |
| Na mg/L | | 208 | | 183 | 100 |
| K mg/L | | 123 | | 112 | 50 |
| Fe mg/L | | 36 | | 41 | 50 |
| Al mg/L | | 32 | | 25 | 50 |
| Si mg/L | | 21 | | 30 | 10 |
| Ca mg/L | | 9 | | 12 | 10 |
| Cr mg/L | | 13 | | 8 | 14 |

Except for sodium and potassium, all other impurities can be reduced by filtration to conform to the required specification.

TABLE 2
Results with varying powder mixtures

| | | | | |
|---|---|---|---|---|
| Proposed Vmolar concentration | 1.6 | 2.0 | 2.5 | 3.0 |
| Grams V₂O₅ powder added | 3.8 | 4.0 | 4.6 | 5.5 |
| (>99%) | | | | |
| Grams Hivox added | 10.4 | 13.0 | 15.6 | 19.0 |
| (equivalent V₂O₅ = 119%) | | | | |
| Milliliters sulphuric acid (98%) | 23.0 | 26.0 | 29.0 | 32.0 |
| Chemical results obtained: - | | | | |
| Molar Vanadium | 1.67 | 2.12 | 2.61 | 3.08 |
| Molar sulphate | 4.11 | 4.7 | 5.3 | 5.92 |
| V³⁺:V⁴⁺ | 1.0:1.04 | 1.02:1.0 | 1.0:1.01 | 1.01:1.04 |

1. A process for preparing a crystalline vanadyl sulphate/vanadous sulphate material comprising the steps of:
(i) providing a mixture of vanadium pentoxide (V₂O₅) and vanadium trioxide (V₂O₃);
(ii) adding to the mixture a predetermined volume of a sulphuric acid solution to produce a powder slurry; and
(iii) heating the slurry at a temperature and for a time sufficient to form a crystalline vanadyl sulphate/vanadous sulphate material.

2. A process according to claim 1, wherein the vanadium pentoxide is commercial grade vanadium pentoxide having a V₂O₅ content of 99.5% to 100% with limited impurity content.

3. A process according to anyone claim 1, wherein the vanadium trioxide is commercial grade vanadium trioxide powder having an equivalent V₂O₅ content of 110% to 125%.

4. A process according to claim 1, wherein the sulphuric acid solution is greater than 98% pure sulphuric acid.

5. A process according to anyone claim 1 , wherein the mixture has a ratio of V₂O₃ to V₂O₅ of 3 V₂O₃:1 V₂O₅ w/w.

6. A process according to claim 1, further comprising adding a stabilising agent to stabilise an electrolyte produced from the crystalline vanadyl sulphate/vanadous sulphate material.

7. A process according to claim 6, wherein the stabilising agent is chemically pure phosphoric acid.

8. A process according to claim 7, wherein the phosphoric acid is added to the sulphuric acid and slurried with the powder mixture prior to the slurry being heated to form the crystalline material.

9. A process according to claim 1, wherein the slurry is heated at a temperature of about 25° C. to 230° C.

10. A process according to claim 9, wherein the slurry is heated at a temperature of 200° C. to 220° C.

11. A process according to anyone claim 8, wherein the slurry is heated for a period of 30 to 240 minutes.

12. A process according to claim 11, wherein the slurry is heated for a period of 45 to 60 minutes.

13. A process according to claim 1, wherein the crystalline material is cooled, crushed and vacuum packed for delivery.

14. A process according to anyone claim 1, wherein the process takes place in an inert atmosphere within a sealed reaction chamber that is flooded with nitrogen, argon or an other inert gas.

15. A process according to claim 1, wherein mixing of the vanadium pentoxide and vanadium trioxide with the sulphuric acid is a homogenous mixing step, using a high intensity mixer.

16. A process for preparing an electrolyte from a crystalline vanadyl sulphate/vanadous sulphate material comprising the steps of:
(i) providing a mixture of vanadium pentoxide (V₂O₅) and vanadium trioxide (V₂O₃);
(ii) adding to the mixture a predetermined volume of a sulphuric acid solution to produce a powder slurry;
(iii) heating the slurry at a temperature and for a time sufficient to form a crystalline vanadyl sulphate/vanadous sulphate material;
(iv) dissolving the crystalline vanadyl sulphate/vanadous sulphate material in boiling water; and
(v) adding a stabilising agent to stabilise the electrolyte.

17. A process according to claim 16, wherein the stabilising agent is phosphoric acid.

18. A process according to claim 17, wherein the phosphoric acid is added to the sulphuric acid and slurried with the powder mixture prior to the slurry being heated to form the crystalline vanadyl/vanadous sulphate material, and wherein the electrolyte is produced by dissolving the crystalline material in boiling water.

19. A process according to claim 17, wherein the crystalline vanadyl/vanadous sulphate material is first dissolved in boiling water to which the phosphoric acid is then added to produce the electrolyte.

20. A process according to 16, wherein the, crystalline material is dissolved in boiling water in a 50:50 w/w ratio.
